(19) United States
(12) Patent Application Publication
(10) Pub. No.: US 2008/0103857 A1
(43) Pub. Date: May 1, 2008

(54) SYSTEM AND METHOD FOR ENTERPRISE RISK MANAGEMENT

(75) Inventors: STEVE YANKOVICH, SAN JOSE, CA (US); NATHAN HOOVER, LOS GATOS, CA (US); DAVE SPRAGUE, SCOTTS VALLEY, CA (US); HAN-SHEN YUAN, SUNNYVALE, CA (US); ROBIN BAKER, BERKELEY, CA (US); RAJESH BHATIA, HAYWARD, CA (US); ARTHUR ARDIZZONE, CUPERTINO, CA (US)

Correspondence Address: PATENTRY, P.O. BOX 151616, SAN RAFAEL, CA, 94915-1616, US

(73) Assignee: MOVARIS CORPORATION, SAN JOSE, CA (US)

(21) Appl. No.: 11/932,014

(22) Filed: Oct. 31, 2007

Related U.S. Application Data
(63) Continuation-in-part of application No. 10/710,433, filed on Jul. 10, 2004.

(51) Int. Cl. G06Q 10/00

(52) U.S. Cl. 705/7; 705/1

(57) ABSTRACT

A system and method for assessing, controlling, and reporting risk in an enterprise related to governance, risk management, and compliance activities.

### CROSS-REFERENCE TO RELATED APPLICATIONS

The present application is a continuation in part of U.S. patent application Ser. No. 10/710,433 filing date Jul. 10, 2004, first named inventor Yankovich, titled: “Apparatus, method, and system for documenting, performing, and attesting to internal controls for an enterprise”. A co-pending application having the same assignee and sharing at least one common inventor is US 29/283,814 ENTERPRISE RISK MANAGEMENT DISPLAY first named inventor Yankovich, filing date Aug. 24, 2007.

### BACKGROUND

Enterprises are measured primarily on their performance but increasingly there are complex responsibilities to attain internal and external objectives in governance, risk, and compliance. Some of these objectives are expected of public corporations, others apply to large employers, and affect valuation even of privately held companies with significant name recognition. To address a gap that presently separates the activities of performance measurement and compliance measurement, a unified control management framework would both unify and automate processes that underpin both sets of activities. However, heretofore such controls systems as exist are unique and un-extensible. Separate and incompatible systems have evolved for corporate strategy and leadership, Operations, Financial Controls, and Compliance to Sox, HIPPA, Patriot Act, FERC, Turnbull, and other regulatory requirements.

Thus it can be appreciated that what is needed are process automation processes where budgeting and planning is risk adjusted and aware, where compliance and performance initiatives are risk aligned, where financial statements are risk reduced, and where decision making is risk intelligent.

### SUMMARY OF THE INVENTION

The present inventive concept is a method comprising the processes of:
displaying real time status of risk control tasks and of remediating activities;
defining a scoping rule for a risk control which activates scheduling of risk control tasks;
defining a plurality of risks and a plurality of control activities; and
linking a certain control activity to a plurality of risks and a certain risk to a plurality of control activities.

### BRIEF DESCRIPTION OF FIGURES

FIG. 1 is a block diagram of the Movaris Unity—Technical Architecture

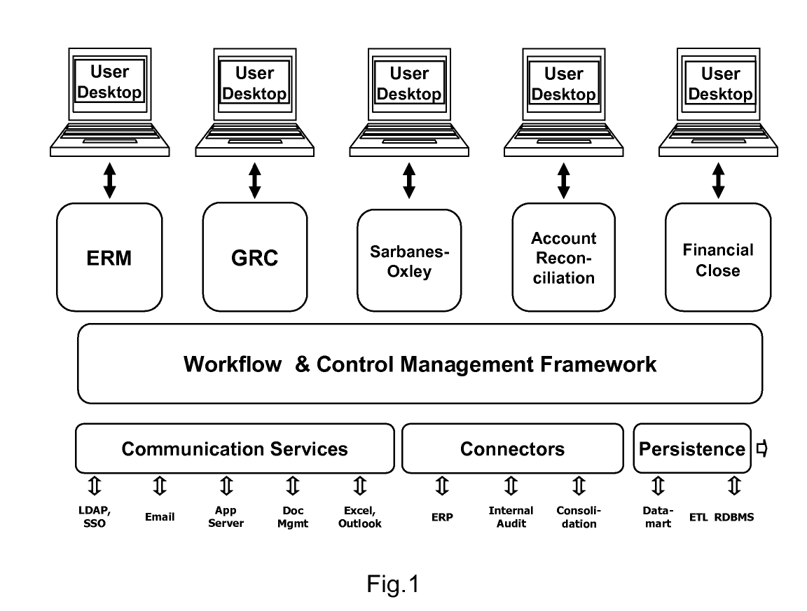

FIG. 2 is a flow chart of the method steps

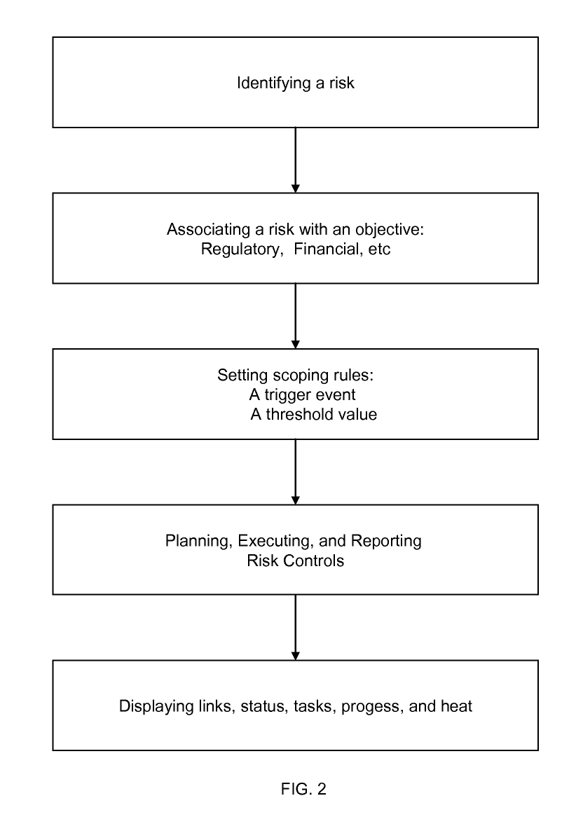

### DETAILED DESCRIPTION

In the present patent application we define governance and performance risks to be financial operation risks and regulatory compliance risks further comprising uncertainty in budgeting planning, financial performance, decision making, and compliance tasks.

Silo Platform Architecture

A process object architecture is described. The present invention comprises 1) shared control objects, 2) a plurality of application silos, 3) a scoping rule evaluator, 4) a scheduler, and 5) a reusable extensible platform.

In the present invention, a reusable extensible platform supports a plurality of hierarchies and supports cross-linking among hierarchies. In an embodiment the platform has a hierarchy of financial accounts and a hierarchy of business units. In another embodiment the platform has a hierarchy of risks and a hierarchy of governance requirements. In another embodiment, the platform has a hierarchy of performers and a hierarchy of financial tasks. The present invention further comprises a scoping rule evaluator. The present invention further comprises a scheduler. A task will be assigned and scheduled if a scoping rule evaluator determines a task to be “in-scope”. A risk may be displayed on a risk dashboard if a scoping rule determines a task to be “in-scope”. A scoping rule developed for one application silo may be reused in another application silo.

As an example of a scoping rule, consider tracking the rate of change of exchange rates between the dollar and foreign currencies. When there is dramatic change, financial close and reporting control activities should be scheduled to restate current and forecast revenues for a multinational corporation. A second application silo for risk management may be linked to the same scoping rule. A third application silo for compliance control may also be linked to the same scoping rule. If there were independent rules in place for each application, there may be inconsistency as well as duplication of effort.

The present invention is a method comprising a risk control planning process, a risk control execution process, and a risk control reporting process whereby an enterprise recognizes a universe of risks, tracks the status of material and significant risks, and includes risk optimization in its budgeting, compliance, financial reporting, and decision making on a day to day basis.

The risk control reporting process includes certifying results of a control task, disclosing a result of a control task, and retaining an audit trail of a control task. The risk control reporting process also has the steps of determining the readiness of a control task, reporting results of a control task, and reviewing effectiveness of a control task.

The risk control execution process includes testing control tasks, performing control tasks, and reviewing the output of control tasks. The risk control execution process further has the steps of managing the workload of control tasks, monitoring the progress of control tasks, and remediating weaknesses of control tasks.

The risk control planning process includes a risk identification process: establishing a control hierarchy of risks, determining risk priorities, and determining risk materiality. The risk control planning process further has the steps of setting risk control scope, scheduling risk controls, and activating risk controls.

The present invention is a system for managing risk in an enterprise comprising a process automation workflow, a plurality of dynamic forms, and a central repository of electronically embodied risk control methods which includes methods tangibly embodied as executable programs encoded on computer readable media and a computer having means for performing the steps of a plurality of processes described as follows.

A computer system provides means for displaying the status of risks assigned the property of “in scope” associated with a business process automation process.

A method for unifying a risk controlled governance and performance management enterprise application comprises the processes of:
identifying a risk among a universe of governance and performance risks applicable to an enterprise;
associating a risk with a performance metric or a governance objective;
and setting scoping rules for risk control.

The above step of setting scoping rules for risk control further comprises at least one of applying a threshold value to a continuous numerical indicator of key risk and identifying a trigger event relating to a loss in the universe of governance and performance risks.

The method of identifying a risk includes the steps of establishing a control hierarchy, determining a risk priority, quantifying a risk materiality to a business process, scheduling controls, and activating a risk control process.

Overall, a computer system provides means for performing a method comprising a risk control planning process, a risk control execution process, and a risk control reporting process whereby an enterprise recognizes a universe of risks, tracks the status of material and significant risks, and includes risk optimization in its budgeting, compliance, financial reporting, and decision making on a day to day basis. The risk control reporting process has the steps of certifying results of a control task, disclosing a result of a control task, retaining an audit trail of a control task, determining the readiness of a control task, reporting results of a control task, and reviewing effectiveness of a control task.

The risk control execution process includes the steps of testing control tasks, performing control tasks, reviewing the output of control tasks, managing the workload of control tasks, monitoring the progress of control tasks, and remediating weaknesses of control tasks. The risk control planning process includes identifying a risk, establishing a control hierarchy of risks, determining relative risk priorities, determining risk materiality, setting risk control scope, scheduling risk controls, and activating risk controls.

Some of the displays which embody the invention on a computer attached display provide means for:
displaying a list of risk controls organized by relative impact on financial statement line items,
displaying progress of risk universe control activities according to on-time, late, and early,
displaying a heat map view of risk universe,
displaying real time status of risk tasks and remediation activities,
displaying for a single risk control its day to day compliance,
applying scoping rules to compliance activities, and
linking control activities to risk universe.
   An embodiment of the method further comprises displaying for a risk control its status if done, passed, late, and failed and its applicable period, and its impact, owner and due date if active or late. For impact a pie chart may show relative shares of high medium or low impact in the late or failed control set.

The present inventive concept is distinguished from prior art in a number of ways.

The present invention is distinguished from conventional methods by displaying real time status of risk control tasks and of remediating activities. This display highlights to management areas which need to be resourced and monitored for tangible improvement. Escalation of issues to policy decision makers can ameliorate potential crises during the decision loop which is current. This allows proactive rather than reactive management.

The present invention is distinguished from conventional methods by defining a scoping rule for a risk control which activates scheduling of risk control tasks. Scoping was discovered by the applicant to be essential for practical implementation in real world large enterprises because the number of potentially schedulable tasks expanded beyond initial estimates. Evaluating scoping rules is performed as an independent process from the scheduler and only risk control tasks that are “in-scope” become visible to the scheduler. Once defined, a scoping rule may be linked to a plurality of risk controls and risk control activities, increasing its utility.

The present invention is distinguished from conventional methods by defining a plurality of risks and a plurality of control activities. Each risk has at least one risk control which has at least one control activity. The number of control activities which can be assigned to performers can be very large and potentially overwhelming. For efficiency, some control activities may be useful on more than one risk or risk control.

The present invention is distinguished from conventional methods by linking a certain control activity to a plurality of risks and a certain risk to a plurality of control activities. Instead of being merely a hierarchy of control activities related to a risk, the many to many linking of a control activity to a plurality of risks and a risk to a plurality of control activities creates a complex graph rather than a tree.

### CONCLUSION

The present invention provides a unified process and platform for the management of all enterprise performance and controls for governance, risk, and compliance activities. The platform allows extension as new standards bodies, government regulators, or financial opinion leaders add financial and behavioral metrics to enterprise performance.

A process automation process records and tracks activity scheduled and performed to control and remediate risks according to the needs of each enterprise. Risks are defined, assessed, evaluated, and remediated from a central repository by dynamic forms presented for action or reportage. The present invention comprises a number of processes, steps, and methods that together drive a risk control planning process, a risk control execution process, and a risk control reporting process whereby an enterprise recognizes a universe of risks, tracks the status of material and significant risks, and includes risk optimization in its budgeting, compliance, financial reporting, and decision making on a day to day basis.

The present invention comprises 1) shared control objects, 2) a plurality of application silos, 3) a scoping rule evaluator, 4) a scheduler, and 5) a reusable platform. The reusable platform supports a plurality of hierarchies and supports cross linking among hierarchies. Risk control management is one application enabled by the system. The present invention is a system providing means for performing a method comprising the processes of:
displaying real time status of risk control tasks and of remediating activities;
defining a scoping rule for a risk control which activates scheduling of risk control tasks;
defining a plurality of risks and a plurality of control activities; and
linking a control activity to a plurality of risks and a risk to a plurality of control activities.

It is to be understood that the above-described embodiments are illustrative of only a few of the many possible specific embodiments, which can represent the principles of the invention. Numerous and varied other arrangements can be readily devised in accordance with these principles without departing from the spirit and scope of the invention as fully claimed below.

What is claimed is:

1. A system for managing risk in an enterprise comprising a process automation workflow, a plurality of dynamic forms, and a central repository of electronically embodied risk control methods.

2. A method for unifying a risk controlled governance and performance management enterprise application comprising the processes of:
identifying a risk among a universe of governance and performance risks applicable to an enterprise;
associating a risk with a performance metric or a governance objective; and
setting scoping rules for risk control.

3. The method of claim two wherein the step of setting scoping rules for risk control further comprises at least one of
applying a threshold value to a continuous numerical indicator of key risk and identifying a trigger event relating to a loss in the universe of governance and performance risks.

4. The method of claim two wherein governance and performance risks comprise financial operation risks and regulatory compliance risks.

5. The method of claim four wherein risks further comprise uncertainty in budgeting planning, financial performance, decision making, and compliance tasks.

6. The method of claim two further comprising displaying the status of risks assigned the property of “in scope” associated with a business process automation process.

7. The method of claim two wherein identifying a risk comprises the steps of
establishing a control hierarchy,
determining a risk priority,
quantifying a risk materiality to a business process,
scheduling controls, and
activating a risk control process.

8. A method comprising a risk control planning process,
a risk control execution process, and
a risk control reporting process
whereby an enterprise recognizes a universe of risks, tracks the status of material and significant risks, and includes risk optimization in its budgeting, compliance, financial reporting, and decision making on a day to day basis.

9. The risk control reporting process of claim eight comprising the steps of certifying results of a control task,
disclosing a result of a control task, and
retaining an audit trail of a control task.

10. The risk control reporting process of claim nine further comprising the steps of
determining the readiness of a control task,
reporting results of a control task, and
reviewing effectiveness of a control task.

11. The risk control execution process of claim eight comprising the steps of
testing control tasks,
performing control tasks, and
reviewing the output of control tasks.

12. The risk control execution process of claim eleven further comprising
managing the workload of control tasks,
monitoring the progress of control tasks, and
remediating weaknesses of control tasks.

13. The risk control planning process of claim eight comprising the steps of
identifying a risk,
establishing a control hierarchy of risks,
determining risk priorities, and
determining risk materiality.

14. The risk control planning process of claim thirteen further comprising the steps
of setting risk control scope,
scheduling risk controls, and
activating risk controls.

15. The method of claim eight further comprising the step of displaying a list of on-time and late risks organized by relative impact on financial statement line items.

16. The method of claim eight further comprising the step of displaying progress of risk universe control activities according to on-time, and late.

17. The method of claim eight further comprising the step of displaying a heat map view of risk universe.

18. The method of claim eight further comprising the step of displaying real time status of risk tasks and remediation activities.

19. The method of claim eight further comprising the step of displaying for a risk control its status if done, passed, late, and failed and its applicable period ,and its impact, owner and due date if active or late.

20. The method of claim eight further comprising the step of applying scoping rules to a compliance activity as a condition of scheduling a compliance activity.

21. The method of claim eight further comprising the step of linking a control activity to a member of a risk universe.

22. An article of manufacture comprising computer readable electronic media in which is encoded a program product adapted to control a processor, tangibly embodying a method for managing risk in an enterprise comprising a process automation workflow comprising the processes of
identifying a risk among a universe of governance and performance risks;
associating a risk with a performance metric; and
setting scoping rules for risk control.

23. The article of claim 22 further comprising:
applying a threshold value to a continuous numerical indicator of key risk and identifying a trigger event relating to a loss;
displaying the status of risks assigned the property of “in-scope”,
displaying the status of risk controls as “on-time”, “late”, and its impact, owner, and due date if active or late.

24. The article of claim 22 further comprising:
establishing a control hierarchy,
determining relative risk priority,
quantifying risk materiality, and
scheduling and activating a risk control process.

25. A method comprising the processes of:
displaying real time status of risk control tasks and of remediating activities;
defining a scoping rule for a risk control which activates scheduling of risk control tasks;
defining a plurality of risks and a plurality of control activities; and
linking a control activity to a plurality of risks and a risk to a plurality of control activities.
